(19) United States
(12) Patent Application Publication
(10) Pub. No.: US 2026/0233579 A1
(43) Pub. Date: Aug. 13, 2026

(54) METHOD FOR CONTROLLING THE SECONDARY CIRCUIT OF A HEAT PUMP

(71) Applicant: VOLKSWAGEN AKTIENGESELLSCHAFT, Wolfsburg (DE)

(72) Inventors: Johannes Stockhammer, Wolfsburg (DE); Timo Sandro Schmidt, Lünen (DE)

(21) Appl. No.: 19/150,444

(22) PCT Filed: Jan. 10, 2024
(86) PCT No.: PCT/EP2024/050506

§ 371 Date: Jul. 23, 2025

(30) Foreign Application Priority Data
Jan. 26, 2023 (DE) 10 2023 200 636.7

(51) Int. Cl. B60H 1/00; B60H 1/14

(52) U.S. Cl. CPC B60H 1/00885; B60H 1/00278; B60H 1/143; B60H 2001/00307

(57) ABSTRACT

Technologies and techniques for controlling a secondary circuit of a heat pump in which a coolant circulates. An air-coolant heat exchanger transfers heat from ambient air to the coolant, which is directed to an electric or electronic component at a first temperature. The coolant absorbs heat from the component and is then conveyed to a coolant-refrigerant heat exchanger at a second temperature. The coolant-refrigerant heat exchanger extracts heat from the coolant and transfers it to a consumer. The coolant, cooled by the coolant-refrigerant heat exchanger, returns to the air-coolant heat exchanger. The first and second temperatures are controlled to maximize heat absorption during heat transfer to the consumer.

### RELATED APPLICATIONS

The present application claims priority to International Patent Application No. PCT/EP2024/050506 to Stockhammer, et al., filed Jan. 10, 2024, which claims priority from German Patent App. No. DE 10 2023 200 636.7, filed Jan. 26, 2023, the contents of each being incorporated by reference in their entirety herein.

### TECHNICAL FIELD

The present disclosure relates to technologies and techniques for controlling a secondary circuit heat pump comprising a coolant circuit in which a coolant circulates. In the first step, the coolant absorbs heat from the surrounding area with the aid of an air-coolant heat exchanger through which both ambient air and the coolant flow. The coolant, having reached the adjusted temperature, is then passed on to an electronic component or unit.

Using a sensor, the temperature of the coolant can be detected downstream from the air-coolant heat exchanger and, in a further embodiment, also downstream from the refrigerant-coolant heat exchanger.

In the second step, heat from at least one component is absorbed by the coolant, which is subsequently passed on to the coolant-refrigerant heat exchanger. In the third step, heat is withdrawn from the coolant by the coolant-refrigerant heat exchanger and fed to a consumer. The coolant, cooled in the coolant-refrigerant heat exchanger, is then conducted back to the air-coolant heat exchanger at the temperature adjusted by the control system.

The control system employed maximizes the heat absorption of the coolant from the air-refrigerant heat exchanger and the electric or electronic component or unit.

The present disclosure furthermore relates to the secondary circuit of a heat pump and to a vehicle comprising a heat pump with a secondary circuit.

### BACKGROUND

In electrically driven vehicles, such as those equipped with an electric motor that receives driving energy from onboard batteries, the heat required for heating the vehicle cabin is produced from various energy sources. The air in the vehicle cabin can be heated using electrical energy from the battery; however, this reduces the energy available for driving and limits the vehicle's range. Generating heat from thermal energy sources that are not suitable for heating the vehicle cabin requires heat pumps to adjust the temperature level. Heat pumps can withdraw heat from the ambient air, absorb lost heat from components within the vehicle, and transfer it to the vehicle cabin. Additionally, factors such as weight and size play a significant role in the development of heat pumps in vehicles with electric drives, as they influence the maximum range of the vehicle. Space for installing units is typically limited, necessitating weight savings and optimization of the vehicle's aerodynamics.

Solutions addressing this recognized problem are known in the prior art and involve appropriately designed air-source heat pumps. For example, KR10-2018-0078074 A discloses an air-source heat pump for a vehicle, which includes a first coolant circuit for a first coolant and a second coolant circuit for a second coolant. The first coolant circuit features a compressor that compresses the first coolant and circulates it through the circuit, an internal heat exchanger that extracts heat from the air inside the vehicle, and an external heat exchanger that draws heat from the ambient air. The internal and external heat exchangers are connected via a line that includes a diffuser. The first and second coolant circuits are interconnected through an additional heat exchanger, allowing the first coolant to transfer heat to the second coolant. The second coolant circuit regulates the temperature of the passenger compartment. WO 2010/001116 A2 describes a control system for a heat exchanger that includes means for determining a dew point. This heat exchanger is part of a space heating system. The control system determines the dew point temperature of the ambient air and controls an air-source heat pump used for climate regulation within the space to prevent condensation based on the specific climate conditions present.

There is a need for a method to control the temperature of the passenger compartment in an electrically driven vehicle, along with a corresponding device, to minimize the impact of the heating operation on the range of the vehicle.

### SUMMARY

Some aspects of the present disclosure are disclosed by various technologies and techniques for controlling a secondary circuit of a heat pump in which a coolant circulates as described in the independent claims. Other aspects are disclosed in the subject matter of the respective dependent subclaims.

One aspect of the present disclosure relates to a method for controlling the secondary circuit of a heat pump in which a coolant circulates. The coolant reaches the coolant-refrigerant heat exchanger at an arbitrary flow temperature and is cooled down to the target temperature, with heat from the coolant being transferred by the heat pump to consumers, such as the vehicle interior, battery, or heat accumulator. A closed-loop or open-loop control system monitors the temperature upstream of the air-coolant heat exchanger and maintains the temperature within the component limits through control interventions.

Another aspect relates to a heat pump, wherein the heat pump is used to produce heat from at least one electric or electronic component or unit of an electrically driven vehicle and to control the temperature of a consumer of the vehicle.

In some examples, the heat pump comprises a secondary coolant circuit, wherein the coolant circuit includes an air-coolant heat exchanger comprising a device that takes in ambient air and conducts it through the heat exchanger and a device that controls the air flow through the air-coolant heat exchanger, a pump that controls the coolant mass flow, and a coolant-refrigerant heat exchanger and connecting lines. Furthermore, an electric or electronic component or unit and temperature sensors are present in the coolant circuit.

Another aspect of the present disclosure relates to an electrically driven vehicle comprising a battery array, wherein the battery array provides the energy for the electric drive, wherein the vehicle comprises a heat pump having a secondary circuit, such as is described herein.

### BRIEF DESCRIPTION OF THE DRAWINGS

Respective exemplary embodiments of the described method, the described indirect air-source heat pump, and the vehicle comprising the indirect air-source heat pump will be described in greater detail hereafter. In the drawings in detail:

FIG. 1 illustrates a method for controlling an indirect air-source heat pump, according to some aspects of the present disclosure;

FIG. 2 illustrates an indirect air-source heat pump for a vehicle comprising an electric motor, according to some aspects of the present disclosure; and

FIG. 3 illustrates a vehicle comprising an electric motor and the indirect air-source heat pump from FIG. 2, according to some aspects of the present disclosure.

### DETAILED DESCRIPTION

In some embodiments, a method for controlling a secondary circuit of a heat pump, in which a coolant circulates, includes a first step wherein the coolant absorbs heat from ambient air via an air-coolant heat exchanger. The air-coolant heat exchanger transfers heat from the ambient air to the coolant, raising the coolant's temperature to a target temperature. The air-coolant heat exchanger may include a device, such as a fan, configured to draw in ambient air and direct it through the heat exchanger. An adjustable radiator grille may also regulate air flow. The coolant is then directed to an electric or electronic component or unit via a first line section.

A temperature sensor may measure the coolant's temperature downstream of the air-coolant heat exchanger and upstream of the component to be cooled. The measured temperature is transmitted to a processor or control system. When multiple components are cooled sequentially by the coolant, a sensor may measure the coolant's temperature upstream of each component. Additionally, the coolant's temperature may be measured downstream of the last component to be cooled.

In a second step, the coolant absorbs heat from the electric or electronic component or unit. The coolant is then directed from the component to a coolant-refrigerant heat exchanger via a second line section of the coolant circuit.

In a third step, the coolant-refrigerant heat exchanger extracts heat from the coolant and transfers it to a consumer via the heat pump, cooling the coolant to the target temperature. The heat pump includes a refrigerant circuit that absorbs thermal energy at a low temperature level at the coolant-refrigerant heat exchanger and delivers it to a consumer at a higher temperature level.

The heat exchanger units are interconnected by lines. Each line section may comprise a flexible hose adapted to the installation environment.

When the coolant's temperature in a line section is below the ambient temperature, the line section's surface may facilitate energy exchange with the ambient air, allowing heat from the ambient air to transfer to the coolant. For example, the coolant's temperature at the inlet of the air-coolant heat exchanger may be higher than at the outlet of the coolant-refrigerant heat exchanger. The extent of this energy transfer may be influenced by the hose material, constituting an additional step in some embodiments.

The first, second, and third line sections, together with the coolant-refrigerant heat exchanger, the air-coolant heat exchanger, and at least one electric or electronic component or unit, form the coolant circuit.

In some embodiments, a delivery device, such as a pump, is integrated into the closed coolant circuit to circulate the coolant. The pump may be positioned in the second line section connecting the electric or electronic component or unit to the coolant-refrigerant heat exchanger. The pump ensures sufficient coolant mass flow. In some embodiments, the pump is a variable displacement pump, allowing adjustment of the coolant mass flow or flow rate via an open-loop or closed-loop control system.

In some embodiments, the at least one electric or electronic component or unit is a traction component of an electrically driven vehicle, such as an electric motor, a DC-to-DC converter, a DC-to-AC converter, a battery array, or a component of the battery array for operating the electric drive motor.

In some embodiments, the heat extracted in the third step by the coolant-refrigerant heat exchanger is used to regulate the temperature of a passenger compartment in a battery-electric vehicle. The heat transferred from the coolant to the refrigerant may be used to heat the passenger compartment, with the heating temperature adjustable by an occupant. In further embodiments, the heat may regulate the battery's temperature or charge a heat accumulator.

In some embodiments, a first sensor measures the ambient air temperature near the air-coolant heat exchanger, and a second sensor measures the air moisture. The sensor data are transmitted as signals to the processor, which determines the target temperature based on these values and stored characteristic data of the components. The target temperature is then transmitted to the control system. Additionally, sensors measure the coolant temperature in the first and third line sections, with these measurements sent to the control system. The first and second sensors may be combined into an intelligent sensor that directly determines the dew point temperature from the ambient air's moisture and temperature, transmitting it to the processor.

In the first and/or third steps, the control system optimizes heat absorption by adjusting the heat pump, coolant pump, radiator grille, and fan to maximize heat absorption based on defined target temperatures.

For example, the target temperature of the coolant may be set to avoid falling below the ambient air's dew point temperature. In some embodiments, the third line section is exposed to ambient air, forming an additional heat exchanger with the surrounding environment, where the coolant's temperature is influenced by the ambient air.

In some embodiments, the heat pump includes a first sensor configured to measure ambient air temperature, a second sensor to measure air moisture, a processor, and a control system for managing the coolant circuit. The sensors transmit measured values to the processor, which calculates target temperatures using the sensor data and stored characteristic data of the electric or electronic components. These target temperatures are sent to the control system as control variables, enabling the coolant-refrigerant heat exchanger and heat pump to adjust the coolant's temperature to substantially meet the calculated target temperatures.

In some embodiments, the coolant in the secondary circuit is water, such as distilled water with a freezing point below 0° C., or preferably a mixture of glycol and distilled water. When directly cooling electric motor windings or batteries, the coolant may be an oil.

In some embodiments, the electric or electronic component or unit includes a cooling structure through which the coolant flows. The cooling structure may be a cooling plate connected to batteries or battery array components, a cooling housing with channels for a motor or motor parts, or a system for spraying coolant directly onto the winding heads of an electric motor in a motor housing. The component may be a traction component, such as an electric motor, battery array, DC-to-DC converter, or DC-to-AC converter.

In some embodiments, the coolant circuit includes an additional temperature sensor that measures the coolant temperature upstream of the air-coolant heat exchanger and transmits it to the control system. The control system adjusts the heat pump's output or the refrigerant's temperature in the coolant-refrigerant heat exchanger if the coolant temperature falls below or exceeds a specified target value.

The target temperature is determined based on the limits of the electric or electronic component or unit, with the most sensitive component defining the temperature limits.

For example, setting the target temperature to match the ambient air's dew point prevents condensation of air moisture on components in the coolant circuit, avoiding potential damage from condensate or ice, such as corrosion or mechanical damage from freezing.

The line sections of the coolant circuit may be at least partially insulated. Some or all line sections may comprise flexible hoses adaptable to the installation environment. The hose material may facilitate heat transfer from ambient air to the coolant. When ice forms on the hose's exterior at ambient or water temperatures below 0° C., the hose's flexibility may allow ice to break off during vehicle operation.

The heat pump's output depends on a high temperature differential between the coolant and the air flowing through the air-coolant heat exchanger. A larger temperature differential enables greater energy transfer from the ambient air to the vehicle's interior.

In some embodiments, when a battery-electric vehicle with the disclosed heat pump operates in an ambient temperature below 15° C. and the passenger compartment requests heating, the control system functions as follows. Sensors detect the current temperatures upstream of the air-coolant heat exchanger and the component. The processor calculates target temperatures based on stored characteristic data, ambient temperature, and air moisture. If condensation is undesirable, the target temperature, based on the components or traction components, aligns with the ambient air's dew point. When multiple components are present, the most sensitive component defines the target temperature.

The control system uses the heat reduction at the coolant-refrigerant heat exchanger to set the target temperature at the air-coolant heat exchanger.

The control system maximizes heat absorption at the air-coolant heat exchanger and the component through the target temperature, while protecting the components, resulting in improved energy efficiency compared to conventional methods and devices.

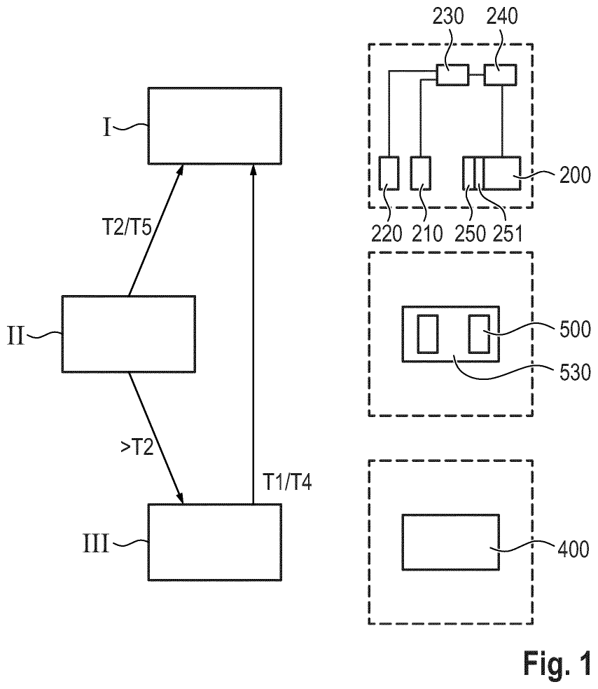

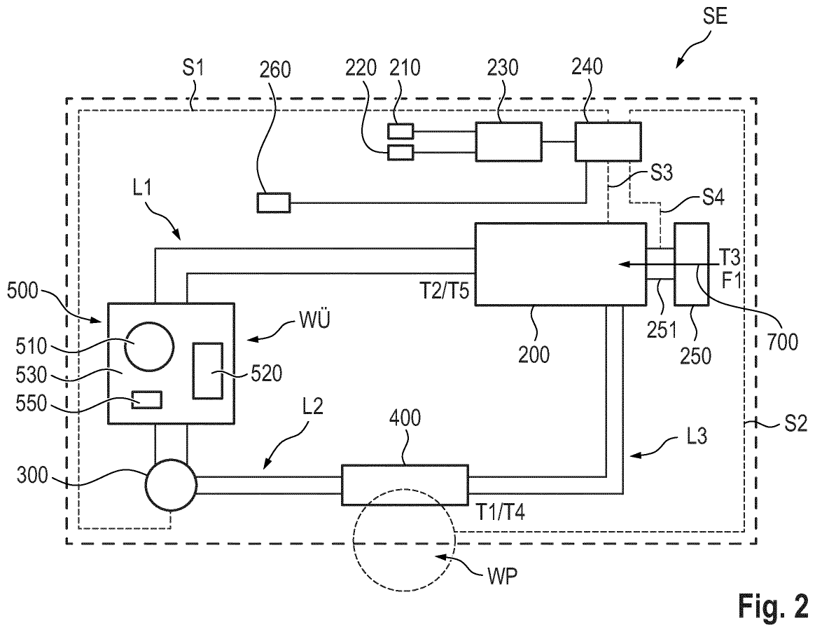

FIG. 1 shows a sketch of a method for controlling the secondary circuit of a heat pump WP, as illustrated in FIG. 2.

The method comprises a first step I, in which heat from the surrounding area is transferred to the coolant using at least one air-coolant heat exchanger 200, through which the coolant and the ambient air 700 (FIG. 2) flow. By means of control interventions at the heat pump WP and the devices 250, 251, and 300, the coolant temperature T2 is adjusted to the target temperature T7, while the coolant temperature T1 is adjusted to the target temperature T4 (FIG. 2). To determine the target temperatures T4 and T5, a sensor 210 measures the air temperature and a sensor 220 measures the air moisture of the ambient air 700. The sensors 210 and 220 transmit the measured values to a processor 230. A target temperature calculation is integrated within the processor 230. Using values from the sensors and the stored characteristic data of the components 500, the processor determines the target temperatures T4 and T5 for the coolant. The processor 230 sends these target temperature values to a control system 240, which uses the received temperature values as control variables to effectively adjust the coolant temperature to the target temperatures through control interventions.

The coolant at the target temperature T5 is then directed to a component 500. The component 500 is an electric or electronic device that generates heat during operation.

In a second step II, the coolant flows through the component 500 or, for example, a cooling plate 530 for the component 500 or a cooling housing surrounding the component 500. Heat exchange occurs as the coolant partially absorbs heat from the component 500 through convection and transports it away. The coolant exits the component 500 at a temperature higher than T2.

The coolant is then fed to a coolant-refrigerant heat exchanger 400, where, in a third step III, the heat from the coolant is transferred to a refrigerant in the coolant-refrigerant heat exchanger 400, causing the coolant to exit with a temperature T1 that is lower than the temperature at the inlet of the coolant-refrigerant heat exchanger 400. The heat produced can be utilized to regulate the temperature of a consumer in the vehicle 100.

The air-coolant heat exchanger 200 is a heat exchanger WÜ through which the coolant of the coolant circuit and the ambient air 700 flow. To direct the ambient air 700 into and through the air-coolant heat exchanger 200, a fan 250 is positioned at the air inlet, which draws in ambient air 700 and delivers it into the air-coolant heat exchanger 200. A device 251 additionally controls the airflow through the air-coolant heat exchanger 200. The task of the air-coolant heat exchanger 200 is to absorb heat from the ambient air 700 and transfer it to the coolant.

The processor 230 calculates the target temperatures T4 and T5 based on the ambient temperature T3, the air moisture F1, and the stored characteristic data of the components 500. The target temperatures T4 and T5 are transmitted to a control system 240.

To calculate the target temperatures T4 and T5, the secondary circuit of the heat pump WP includes a sensor 210 that measures the temperature of the ambient air 700, and a sensor 220 that measures the air moisture of the ambient air 700. The sensors 210 and 220 send the measured values for the temperature and moisture of the ambient air 700 to a processor 230. Using the stored characteristic data of the components 500, the processor 230 determines the target temperature T4 for T1 and the target temperature T5 for T2, then relays the results to a control system 240. The control system 240 uses the target temperatures T4 and T5 as control variables to adjust, via control lines S1, S2, S3, and S4, the control parameters at the delivery device 300, the heat pump WP, the device 250, and the device 251, bringing the coolant temperatures T1 and T2 closer to the target temperatures.

The coolant, with a temperature T2 that substantially corresponds to the target temperature T5, is conducted via the first line section L1 to a heat exchanger WÜ. A sensor 260 is placed in the first line section L1 to measure the temperature of the coolant downstream from the air-coolant heat exchanger 200 and transmit the result to the control system 240, allowing it to determine whether the temperature in the first line section L1 substantially matches the target temperature T5.

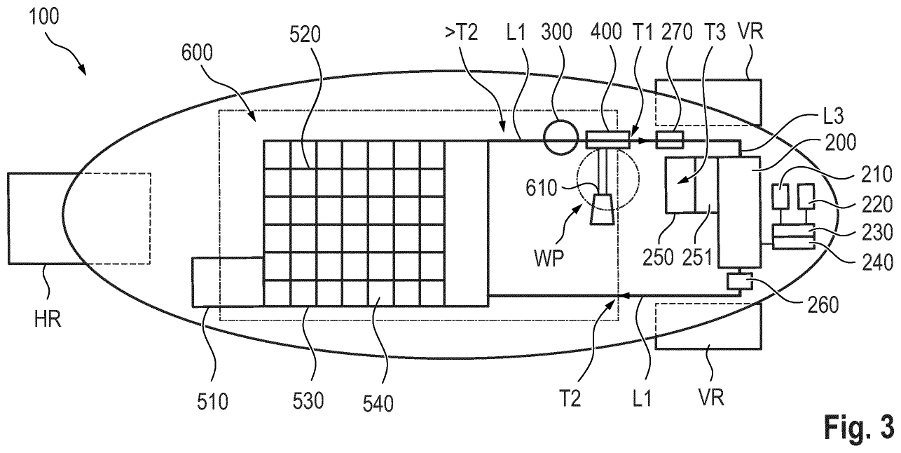

The heat exchanger WÜ comprises, for example, a cooling plate 530 for a component 500 or a cooling housing of a component 500. The component 500 is, for example, an electric or electronic unit 500 for driving an electric vehicle 100 (FIG. 3), which generates heat during operation. As a result of this method, the heat from the component 500 is used by means of a heat exchanger 610 to control the temperature of a consumer 600, such as the passenger compartment. The component 500 can be, for example, an electric motor 510, a battery array 520, a DC-to-DC converter 550, or a DC-to-AC converter. Since the coolant flowing through the heat exchanger WÜ has a temperature that is within the temperature limits of the component 500, corresponding at least substantially to the calculated target temperature T2, the component is protected against impermissible thermal load. For example, no or only maximally permissible condensation or icing can occur on the component 500 that is exposed to the ambient air 700, which protects the component 500 against damage and destruction by water or ice.

As it flows through the heat exchanger WÜ, the coolant at least partly absorbs the heat from the component 500 and removes it. In the process, the coolant is heated to a temperature greater than the inlet temperature T2. From the heat exchanger WU, the coolant, now at a temperature greater than T2, is conducted in the second line section L2 by a delivery device 300 to a coolant-refrigerant heat exchanger 400. The delivery device 300 is an electrically driven pump in this exemplary embodiment. In the second line section L2 and in the delivery device 300, the coolant can give off energy to the ambient air 700. However, this energy loss can be minimized or completely avoided by thermally insulating the second line section L2 and the delivery device.

The coolant-refrigerant heat exchanger 400 is an additional heat exchanger in which the energy from the coolant is transferred to a refrigerant circuit. The heat pump WP absorbs heat at the coolant-refrigerant heat exchanger and releases it at a higher temperature level, for example, to the passenger compartment of the electric vehicle 100 (FIG. 3) or another consumer 600. Upon request, the energy extracted from the coolant can be made available to the passenger compartment or one or more other consumers 600 as heat by means of known methods.

The coolant exits the coolant-refrigerant heat exchanger 400 at a temperature T1 and is conducted via the third line section L3 to the air-coolant heat exchanger 200. The third line section L3 can be a hose connection comprising a flexible hose. The flexible hose allows the third line section L3 to be easily adapted to the installation situation in the electric vehicle 100 (FIG. 3). Additionally, the flexible hose has the advantage that if ice forms on its surface due to low ambient temperature or low refrigerant temperature, movements of the hose while the electric vehicle 100 (FIG. 3) is being driven can cause the ice to break off, thereby preventing the formation of a thick ice layer.

During the transport of the coolant from the coolant-refrigerant heat exchanger 400 to the air-coolant heat exchanger 200, the third line section L3 can serve as an additional heat exchanger in which energy from the ambient air 700 is transferred to the coolant. If this occurs, the coolant at the inlet to the air-coolant heat exchanger 200 has a temperature that is higher than the temperature at the outlet of the coolant-refrigerant heat exchanger 400.

FIG. 3 shows a sketch of an electric vehicle 100 with a driven rear wheel HR and two front wheels VR, along with an electric motor 510 and a battery array 520 that provides energy for driving the electric motor 510. The battery array is arranged on a cooling plate 530, which contains cooling channels 540 through which a coolant flows, removing heat from the battery array 520. The coolant can then be directed through the electric motor 510 to cool it.

The battery array 520 is integrated into the secondary circuit of a heat pump (FIG. 2), the control of which maximizes the heat absorption of the coolant from the air-coolant heat exchanger 200 and component 500. The secondary circuit of the heat pump WP (FIG. 2) comprises an air-coolant heat exchanger 200, a line system that, in this exemplary embodiment, includes the line sections L1, L2, and L3, a delivery element 300 for circulating the coolant in the coolant circuit, and a coolant-refrigerant heat exchanger 400.

The air-coolant heat exchanger 200 is a heat exchanger through which the coolant of the coolant circuit and the ambient air 700 (FIG. 2) flow. To facilitate the air mass flow of the ambient air 700 into and through the air-coolant heat exchanger 200, a device 250 is positioned at the air inlet, which draws in ambient air 700 and directs it into the air-coolant heat exchanger 200, along with a controllable radiator grille 251. The goal is to transfer the maximum possible amount of heat to the coolant without causing an unacceptable thermal load on the components.

The target temperatures T4 and T5 are calculated based on sensors 210 and 220, as well as the stored characteristic data of component 500 in the processor 230. The processor 230 determines the target temperatures T4 and T5 and relays the results to a control system 240. Through control interventions at devices 250, 251, and 300 and the heat pump WP, the control system 240 adjusts the target temperatures T4 and T5 to T1 or T2 to ensure that heat absorption in method step III is maximized.

The coolant, having the target temperature T5 calculated by the processor 230, is conducted via the first line section L1 to the electric or electronic component or unit 500 and/or the cooling plate 530 of the battery array. Since the coolant, when flowing through the cooling plate 530, has a temperature that substantially corresponds to the target temperature T5, no impermissible thermal load on the component 500 can occur. For example, no or only maximally permissible condensate formation or icing occurs at the battery array 520 that is exposed to the ambient air 700.

As it flows through the cooling plate 530, the coolant partially absorbs and removes heat from the battery array 520. In the process, the coolant is heated to a temperature greater than T2. From the battery array 520, the coolant with this temperature is conducted in the second line section L2 by a delivery device 300 to a coolant-refrigerant heat exchanger 400.

The coolant-refrigerant heat exchanger 400 is an additional heat exchanger in which the energy from the coolant is transferred to a refrigerant circuit. The coolant-refrigerant heat exchanger 400 is connected, for example, via the heat pump WP, to the passenger compartment of the electric consumer 100 (or another consumer). On request, the energy withdrawn from the coolant can be made available to the passenger compartment or other consumers 600 as heat using known methods.

The coolant flows out of the coolant-refrigerant heat exchanger 400 at a temperature T1 and is conducted via the third line section L3 to the air-refrigerant heat exchanger 200. The third line section L3 can be a hose connection comprising a flexible hose. The flexible hose allows the third line section L3 to be easily adapted to the installation situation in the electric vehicle 100. Furthermore, the flexible hose has the advantage that if ice forms on the hose surface due to low ambient temperature or low refrigerant temperature, movements of the hose while the electric vehicle 100 is being driven cause the ice to break off, thereby preventing the formation of a thick ice layer.

During the transport of the coolant from the coolant-refrigerant heat exchanger 400 to the air-coolant heat exchanger 200, the third line section L3 can act as an additional heat exchanger in which energy from the ambient air 700 is transferred to the coolant. If this occurs, the coolant at the inlet to the air-coolant heat exchanger 200 has a temperature T1 that is higher than the temperature at the outlet of the coolant-refrigerant heat exchanger 400.

The task of the computer product according to claim 13 is to calculate the required target temperatures T4 and T5 from the data of sensors 210, 220, 260, and 270, as well as the characteristic data of the electric and electronic components and units 500. It includes all calculation and analytical methods, algorithms, and techniques necessary to control the secondary circuit of a heat pump according to the described claims for maximizing the heat absorption of the refrigerant. This applies regardless of whether the calculations are performed by a processor 230 and/or a control system 240 in the vehicle-such as a microprocessor in a control unit where the required data, parameters, and algorithms are stored-or whether the calculations are conducted in central elements to which the vehicle data are transmitted through communication systems.

### List of Reference Signs

I method step
II method step
III method step
HR rear wheel
WP heat pump
SE secondary circuit of the heat pump
VR front wheel
WÜ heat exchanger
L1 line section
L2 line section
L3 line section
S2 control line
S2 control line
S3 control line
S4 control line
T1 temperature
T2 temperature
T3 temperature ambient air
T4 target temperature for T1
T5 target temperature for T2
F1 moisture ambient air
100 vehicle, electric vehicle
200 air-coolant heat exchanger
210 sensor
220 sensor
225 intelligent sensor
230 processor
240 control system
250 fan
251 device controllable radiator grille
260 sensor
270 sensor
300 delivery device
400 coolant-refrigerant heat exchanger
500 component
510 electric motor, drive
520 battery array
530 cooling plate, cooling structure
540 cooling channel
550 DC-to-DC converter
600 consumer
610 heat exchanger to consumer
700 ambient air

1-10. (canceled)

11. A method for controlling a secondary circuit of a heat pump in which a coolant circulates, comprising:
transferring heat from ambient air to the coolant via an air-coolant heat exchanger through which the coolant and the ambient air flow;
directing the coolant at a first temperature to an electric or electronic component or unit to absorb heat from the component or unit;
conveying the coolant at a second temperature to a coolant-refrigerant heat exchanger to extract heat from the coolant and transfer the extracted heat to a consumer;
controlling the first temperature, the second temperature, or both to maximize heat absorption during the extraction of heat by the coolant-refrigerant heat exchanger; and
returning the coolant, cooled by the coolant-refrigerant heat exchanger, to the air-coolant heat exchanger.

12. The method of claim 11, further comprising circulating the coolant through the secondary circuit using a delivery device integrated into the secondary circuit.

13. The method of claim 11, further comprising:
measuring the first temperature of the coolant using a temperature sensor positioned downstream of the air-coolant heat exchanger and upstream of the component or unit;
transmitting the measured first temperature to a control system; and
adjusting, via the control system, at least one of heat transfer from the coolant-refrigerant heat exchanger by controlling the heat pump, heat transfer from the air-coolant heat exchanger by controlling a fan, heat transfer from the air-coolant heat exchanger by controlling a radiator grille, or circulation of the coolant by controlling a delivery device, to maintain the first temperature within temperature limits of the component or unit.

14. The method of claim 11, wherein, when a plurality of components or units are present, controlling the first temperature includes setting the first temperature within a temperature limit defined by a most sensitive component or unit of the plurality of components or units.

15. The method of claim 11, further comprising:
measuring a third temperature of the coolant using a temperature sensor positioned upstream of the air-coolant heat exchanger;
transmitting the measured third temperature to a control system; and
adjusting, via the control system, at least one of heat transfer from the coolant-refrigerant heat exchanger by controlling the heat pump, heat transfer from the air-coolant heat exchanger by controlling a fan, heat transfer from the air-coolant heat exchanger by controlling a radiator grille, or circulation of the coolant by controlling a delivery device, to maintain the first temperature within temperature limits of the component or unit.

16. The method of claim 11, wherein the electric or electronic component or unit comprises a traction component of an electrically driven vehicle selected from the group consisting of an electric motor, a DC-to-DC converter, a DC-to-AC converter, a battery array, and a component of a battery array for operating an electric drive motor.

17. The method of claim 11, wherein the heat extracted by the coolant-refrigerant heat exchanger is used to regulate a temperature of at least one of a passenger compartment of an electrically driven vehicle, a battery array, a heat accumulator, or another consumer.

18. The method of claim 11, further comprising:
measuring an ambient air temperature and an air moisture of the ambient air using a first sensor and a second sensor, respectively, or determining a dew point temperature of the ambient air using an intelligent sensor; transmitting the measured ambient air temperature, the air moisture, or the dew point temperature to a processor;
determining, via the processor, a first target temperature for the first temperature based on the transmitted values and stored characteristic data of the component or unit; and
transmitting the first target temperature to a control system to control the first temperature within temperature limits of the component or unit.

19. The method of claim 11, wherein the component or unit includes a cooling structure through which the coolant flows, the cooling structure comprising one of a cooling plate, a cooling housing, or a system for spraying coolant onto the component or unit.

20. A system for controlling a secondary circuit of a heat pump in which a coolant circulates, comprising:
an air-coolant heat exchanger configured to transfer heat from ambient air to the coolant flowing through the air-coolant heat exchanger;
a first line section configured to direct the coolant at a first temperature to an electric or electronic component or unit to absorb heat from the component or unit;
a coolant-refrigerant heat exchanger configured to extract heat from the coolant at a second temperature and transfer the extracted heat to a consumer;
a control system configured to control the first temperature, the second temperature, or both to maximize heat absorption during the extraction of heat by the coolant-refrigerant heat exchanger; and
a second line section configured to return the coolant, cooled by the coolant-refrigerant heat exchanger, to the air-coolant heat exchanger.

21. The system of claim 20, further comprising a delivery device integrated into the secondary circuit and configured to circulate the coolant through the secondary circuit.

22. The system of claim 20, further comprising:
a temperature sensor positioned downstream of the air-coolant heat exchanger and upstream of the component or unit, the temperature sensor configured to measure the first temperature of the coolant and transmit the measured first temperature to the control system;
wherein the control system is further configured to adjust at least one of heat transfer from the coolant-refrigerant heat exchanger by controlling the heat pump, heat transfer from the air-coolant heat exchanger by controlling a fan, heat transfer from the air-coolant heat exchanger by controlling a radiator grille, or circulation of the coolant by controlling a delivery device, to maintain the first temperature within temperature limits of the component or unit.

23. The system of claim 20, wherein, when a plurality of components or units are present, the control system is configured to set the first temperature within a temperature limit defined by a most sensitive component or unit of the plurality of components or units.

24. The system of claim 20, further comprising:
a temperature sensor positioned upstream of the air-coolant heat exchanger, the temperature sensor configured to measure a third temperature of the coolant and transmit the measured third temperature to the control system;
wherein the control system is further configured to adjust at least one of heat transfer from the coolant-refrigerant heat exchanger by controlling the heat pump, heat transfer from the air-coolant heat exchanger by controlling a fan, heat transfer from the air-coolant heat exchanger by controlling a radiator grille, or circulation of the coolant by controlling a delivery device, to maintain the first temperature within temperature limits of the component or unit.

25. The system of claim 20, wherein the electric or electronic component or unit comprises a traction component of an electrically driven vehicle selected from the group consisting of an electric motor, a DC-to-DC converter, a DC-to-AC converter, a battery array, and a component of a battery array for operating an electric drive motor.

26. The system of claim 20, wherein the coolant-refrigerant heat exchanger is configured to transfer the extracted heat to regulate a temperature of at least one of a passenger compartment of an electrically driven vehicle, a battery array, a heat accumulator, or another consumer.

27. The system of claim 20, further comprising:
a first sensor configured to measure an ambient air temperature;
a second sensor configured to measure an air moisture of the ambient air, or an intelligent sensor configured to determine a dew point temperature of the ambient air; and
a processor configured to receive the measured ambient air temperature, the air moisture, or the dew point temperature, determine a first target temperature for the first temperature based on the received values and stored characteristic data of the component or unit, and transmit the first target temperature to the control system; wherein the control system is configured to control the first temperature within temperature limits of the component or unit based on the first target temperature.

28. The system of claim 20, wherein the component or unit includes a cooling structure configured to allow the coolant to flow therethrough, the cooling structure comprising one of a cooling plate, a cooling housing, or a system for spraying coolant onto the component or unit.

29. A non-transitory computer-readable storage medium storing instructions that, when executed by a processor, cause the processor to control a secondary circuit of a heat pump in which a coolant circulates by:
causing heat to be transferred from ambient air to the coolant via an air-coolant heat exchanger through which the coolant and the ambient air flow;
causing the coolant to be directed at a first temperature to an electric or electronic component or unit to absorb heat from the component or unit;
causing the coolant to be conveyed at a second temperature to a coolant-refrigerant heat exchanger to extract heat from the coolant and transfer the extracted heat to a consumer;
controlling the first temperature, the second temperature, or both to maximize heat absorption during the extraction of heat by the coolant-refrigerant heat exchanger; and
causing the coolant, cooled by the coolant-refrigerant heat exchanger, to be returned to the air-coolant heat exchanger.

30. The non-transitory computer-readable storage medium of claim 29, wherein the instructions, when executed by the processor, further cause the processor to circulate the coolant through the secondary circuit using a delivery device integrated into the secondary circuit.
